(19) United States
(12) Patent Application Publication
(10) Pub. No.: US 2024/0297456 A1
(43) Pub. Date: Sep. 5, 2024

(54) Foldable plug mechanism applied to multi-national power converter

(71) Applicant: Dongguan Best Travel Electronics Co., Ltd., Dongguan City (CN)

(72) Inventors: Guangli Zeng, Dongguan City (CN); Chengbing Wang, Dongguan City (CN); Feng Wang, Dongguan City (CN)

(21) Appl. No.: 18/590,441

(22) Filed: Feb. 28, 2024

(30) Foreign Application Priority Data
Mar. 3, 2023 (CN) 202310203617.2

(51) Int. Cl. H01R 13/44; H01R 13/502

(52) U.S. Cl. CPC H01R 13/44; H01R 13/502

(57) ABSTRACT

The invention discloses a foldable plug mechanism applied to a multi-national power converter, comprising: a mounting base; a plug assembly rotatably disposed on the mounting base; a locking assembly disposed on the mounting base for locking the plug assembly; and at least one elastic member disposed between the plug assembly and the mounting base. The foldable plug mechanism applied to a multi-national power converter disclosed in the invention can freely fold and unfold a plug assembly according to needs. When folded, the plug mechanism has a small volume, occupies a small space, is well accommodated, is convenient to be carried, and is particularly convenient to be carried abroad. When folded, the pins of the plug assembly are less likely to come into contact with other items without phenomenons of dust, scratching, damage or bending.

### CROSS-REFERENCE TO RELATED APPLICATIONS

The application claims priority of Chinese patent application CN202310203617.2, filed on Mar. 3, 2023, which is incorporated herein by reference in its entireties.

### TECHNICAL FIELD

The invention relates to the field of multi-national power converters, in particular to a foldable plug mechanism applied to a multi-national power converter.

### BACKGROUND ART

In the existing multi-national power converter, the plug is fixed on the housing and is not foldable. The plug cannot be folded in either the use state or the non-use state. Such a structure design has the following disadvantages.

It has a large volume and a big space occupied. Especially when carrying abroad, it is not easy to be stored and carried.

The pins of the plug come into contact with other items and are prone to dust, scratching, damage or even bending.

### SUMMARY OF THE INVENTION

In view of the above-mentioned deficiencies, the object of the invention is to provide a multi-national power converter disclosed in the invention can freely fold and unfold a plug assembly according to needs. When folded, the plug mechanism has a small volume, occupies a small space, is well accommodated, is convenient to be carried, and is particularly convenient to be carried abroad. When folded, the pins of the plug assembly are less likely to come into contact with other items without phenomenons of dust, scratching, damage or bending.

The technical solution adopted by the invention for achieving the above purpose is as follows.

A foldable plug mechanism applied to a multi-national power converter comprises:
a mounting base;
a plug assembly rotatably disposed on the mounting base;
a locking assembly disposed on the mounting base for locking the plug assembly; and
at least one elastic member disposed between the plug assembly and the mounting base.

As a further improvement of the invention, at least one rotation shaft is formed on the plug assembly, and at least one rotation groove into which the rotation shaft is inserted for rotation is formed in the mounting base.

As a further development of the invention, the elastic member is a torsion spring which is sleeved on the periphery of the rotation shaft and one end of which abuts on the mounting base.

As a further improvement of the invention, a clamp groove into which one end of the torsion spring is clamped is formed in the mounting base.

As a further improvement of the invention, a rotation guide seat is provided at the periphery of the rotation shaft, and an arc guide surface is formed at an outer side of the rotation guide seat.

As a further improvement of the invention, the locking assembly comprises a movable member movably disposed on the mounting base and a locking block connected to the movable member; and a locking groove into which the locking block is inserted is formed on the plug assembly.

As a further improvement of the invention, the locking assembly further comprises an operation pushing block disposed at an upper end of the movable member, and a first return spring disposed between the movable member and the mounting base, wherein a first guide slope is formed at an upper end surface of the locking block, and a second guide slope corresponding to the first guide slope is formed at the plug assembly.

As a further improvement of the invention, a guide sliding block is disposed inside the mounting base; a movable cavity is formed at the bottom of the movable member; a guide sliding hole is formed on the movable member to communicate with the movable cavity and allow the guide sliding block to slide; and the first return spring is disposed between the inner wall of the movable cavity and the guide sliding block.

As a further improvement of the invention, the movable member is a rotating member on which a rotating clamp groove is formed.

As a further development of the invention, the movable member is a press rod and the locking block is a first locking hook; the locking assembly also comprises a first press handle connected to an outer end of the press rod and extending outside of the mounting base, and a second return spring disposed between an inner end of the press rod and the mounting base.

As a further improvement of the invention, the locking assembly comprises a press seat movably disposed on the mounting base, two locking arms rotatably disposed on the press seat, a third return spring disposed between the press seat and the mounting base, and a fastener disposed on the mounting base and used for fastening the press seat; a movable groove for moving the press seat, the third return spring and the fastener is formed on the mounting base; and two limiting blocks for limiting the two locking arms are formed on an upper end of the movable groove.

As a further improvement of the invention, a first locking hook is formed at ends of the two locking arms respectively.

As a further refinement of the invention, the fastener is a springing bar with at least one clamp hook formed thereon.

As a further improvement of the invention, at least one protrusion is formed on the press seat; a fastening position for fastening the clamp hook is formed on an upper end of the protrusion; and a slope is formed on a side of the protrusion, the slope being inclined from bottom to top in a direction away from the fastening position.

As a further improvement of the invention, the number of the clamp hooks and the protrusions is two, respectively, and disposed in one-to-one correspondence.

As a further improvement of the invention, a positioning groove is formed at the bottom of the press seat; a positioning post is formed at the bottom of the movable groove; the upper end of the third return spring is inserted into the positioning groove; and the lower end is sleeved on the periphery of the positioning post.

As a further improvement of the invention, the locking assembly comprises two movable seats movably disposed on the mounting base and at least a fourth return spring abutting against the movable seats, wherein a second locking hook is formed on the two movable seats, respectively.

As a further improvement of the invention, a third guide slope is formed on an upper end surface of the second locking hook.

As a further improvement of the invention, a second press handle extending outside the mounting base is connected to the movable seat.

As a further improvement of the invention, the two movable seats are oppositely disposed, and a sleeve post is respectively formed on back surfaces of the two movable seats; and both ends of the fourth return spring are sleeved on the periphery of the sleeve post.

As a further development of the invention, the locking assembly further comprises a press member disposed above the two movable seats and a fifth return spring disposed between the press member and the mounting base.

As a further improvement of the invention, an upper press guide slope is formed on the two movable seats, respectively; and two lower press guide slopes acting on the upper press guide slopes of the two movable seats are formed on the press member, respectively.

As a further improvement of the invention, a fourth guide slope is formed on an upper end surface of the second locking hook.

As a further development of the invention, the number of the fourth return springs is two, one fourth return spring being located between one of the movable seats and the mounting base, and the other fourth return spring being located between the other movable seat and the mounting base.

As a further improvement of the invention, a first guide sliding rail and a first guide sliding bar are respectively formed on one of the two movable seats, and a first sliding groove is formed on the first guide sliding bar; a second guide sliding rail and a second guide sliding bar are respectively formed on the other movable seat, and a second sliding groove is formed on the second guide sliding bar; and the first guide sliding rail is movably clamped into the second sliding groove, and the second guide sliding rail is movably clamped into the first sliding groove.

As a further improvement of the invention, an upper mounting post is formed at a lower end of the press member; a lower mounting groove is formed at the mounting base; and an upper end of the fifth return spring is sleeved on the periphery of the upper mounting post, and a lower end thereof is sleeved on the periphery of the lower mounting groove.

As a further improvement of the invention, the plug assembly comprises a plug body and two pins connected to the plug body; a folding groove is formed on the mounting base, and the folding groove comprises a large groove body for the plug body to rotate; and two side grooves communicating with the large groove body for the two pins to be clamped.

As a further improvement of the invention, at least two sets of conductive elastic members are provided on one side of the mounting base; and an arc-shaped contact spring piece is formed on the conductive elastic member for contacting and conducting a tail end of the plug assembly.

As a further improvement of the invention, a conductive contact clip for inserting and contacting the tail end of the plug assembly is formed on the conductive elastic member; one side of the conductive contact clip is bent and extended inwards to form the arc-shaped contact spring piece; and a free end of the arc-shaped contact spring piece has an arc-shaped covering portion.

As a further improvement of the invention, the mounting base comprises a lower cover and a bracket disposed at one side of the lower cover; the conductive elastic member is disposed in the bracket; and the locking assembly and the plug assembly are respectively disposed on the lower cover.

The invention has the following beneficial effects.

By adding a locking assembly and an elastic member with a special structural design, the plug assembly in a folded state is stably locked by the locking assembly. The plug assembly unlocked is ejected by the elastic member, so as to realize the automatic ejection and unfolding function, which is more convenient and quick compared with a plug assembly in a folded state which is pulled up to an unfolded state by a human hand. Thus, the plug assembly can be freely folded and unfolded according to needs. When folded, the plug mechanism has a small volume, occupies a small space, is well accommodated, is convenient to be carried, and is particularly convenient to be carried abroad. When folded, the pins of the plug assembly are less likely to come into contact with other items without phenomenons of dust, scratching, damage or bending.

By adding an arc-shaped contact spring piece with an arc-shaped covering portion to the conductive elastic member, the arc-shaped covering portion of the arc-shaped contact spring piece directly and tightly covers the tail end of the pin of the plug assembly. As achieving the conducting function, the arc-shaped covering portion of the arc-shaped contact spring piece applies an elastic force to the tail end of the pin to position same, improving the stability of the contact between the pin and the arc-shaped contact spring piece, ensuring the contact performance and good contact, so as to ensure the use of a large current, such as a large current of 15 A.

The above is an overview of the technical scheme of the invention. The following is a further explanation of the invention in combination with the attached drawings and specific implementations.

### BRIEF DESCRIPTION OF THE DRAWINGS

FIG. 1 is an exploded view showing an application of a foldable plug mechanism to a multi-national power converter in Embodiment I;

FIG. 2 is a structurally schematic diagram of a plug assembly in an unfolded state in Embodiment I;

FIG. 3 is a structurally schematic diagram of a plug assembly in a folded state in Embodiment I;

FIG. 4 is a partially structurally schematic diagram in Embodiment I;

FIG. 5 is a cross-section view according to Embodiment I;

FIG. 6 is a structurally schematic diagram of the combination of a plug assembly and a torsion spring in Embodiment I;

FIG. 7 is another cross-section view according to Embodiment I;

FIG. 8 is a structurally schematic diagram of a locking assembly in Embodiment I;

FIG. 9 is a structurally schematic diagram of a plug assembly in an unfolded state in Embodiment II;

FIG. 10 is a structurally schematic diagram of a plug assembly in a folded state in Embodiment II;

FIG. 11 is a structurally schematic diagram of a plug assembly in an unfolded state in Embodiment III;

FIG. 12 is a structurally schematic diagram of a plug assembly in a folded state in Embodiment III;

FIG. 13 is a structurally schematic diagram of a locking assembly when the plug assembly is in an unfolded state in Embodiment IV;

FIG. 14 is a structurally schematic diagram of a locking assembly when the plug assembly is in a folded state in Embodiment IV;

FIG. 15 is a cross-section diagram of a plug assembly in an unfolded state in Embodiment IV;

FIG. 16 is a cross-section diagram of a plug assembly in a folded state in Embodiment IV;

FIG. 17 is a structurally schematic diagram of a plug assembly in an unfolded state in Embodiment IV;

FIG. 18 is a structurally schematic diagram of a plug assembly in a folded state in Embodiment IV;

FIG. 19 is a structurally schematic diagram of a plug assembly in an unfolded state in Embodiment V;

FIG. 20 is a structurally schematic diagram of a plug assembly in a folded state in Embodiment V;

FIG. 21 is a structurally schematic diagram of a plug assembly in an unfolded state in Embodiment VI;

FIG. 22 is a structurally schematic diagram of a plug assembly in a folded state in Embodiment VI;

FIG. 23 is a exploded diagram of a locking assembly in Embodiment VI;

FIG. 24 is a structurally schematic diagram of a locking assembly in Embodiment VI;

FIG. 25 is a cross-section diagram of a locking assembly in Embodiment VI;

FIG. 26 is an exploded view showing an application of a foldable plug mechanism to a multi-national power converter in Embodiment VII;

FIG. 27 is an exploded view of a combination of a plug assembly, a conductive elastic member and a bracket in Embodiment VII;

FIG. 28 is a structurally schematic diagram of a combination of a plug assembly, a conductive elastic member and a bracket in Embodiment VII;

FIG. 29 is a structurally schematic diagram of a combination of a conductive elastic member and a bracket in Embodiment VII;

FIG. 30 is a structurally schematic diagram of inserting pins of a plug assembly into a conductive elastic member in a bracket in Embodiment VII.

### DETAILED DESCRIPTION OF THE INVENTION

In order to further explain the technical means and effects of the invention for achieving the intended purpose, the following detailed description of the embodiments of the invention will be made with reference to the accompanying drawings and preferred embodiments.

### Embodiment I

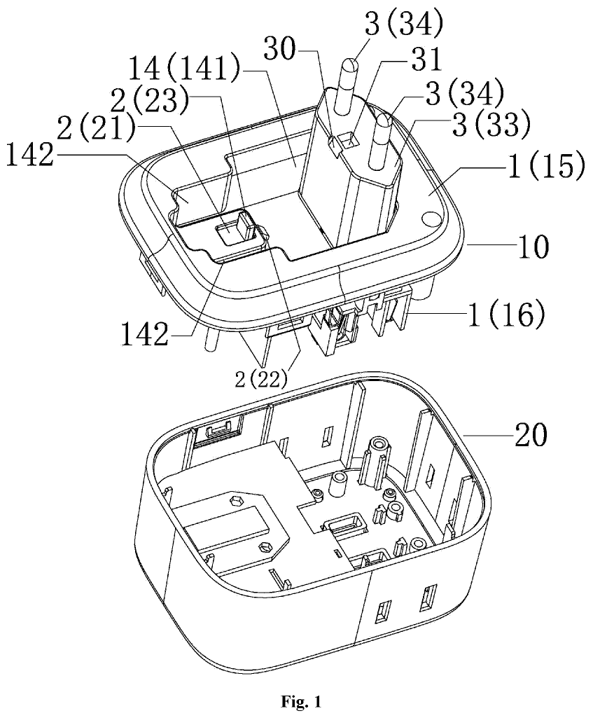

Referring to FIGS. 1 to 4, the present embodiment provides a foldable plug mechanism 10 applied to a multi-national power converter, including:
a mounting base 1;
a plug assembly 3 rotatably disposed on the mounting base 1;
a locking assembly 2 disposed on the mounting base 1 for locking the plug assembly; and
at least one elastic member 4 disposed between the plug assembly 3 and the mounting base 1.

Since the plug assembly 3 is rotatably disposed on the mounting base 1, the plug assembly 3 can be unfolded and folded as long as the plug assembly 3 is swung. The plug assembly 3 in a folded state is stably locked by the locking assembly 2. The plug assembly 3 unlocked is ejected by the elastic member 4, so as to realize the automatic ejection and unfolding function, which is more convenient and quick compared with a plug assembly 3 in a folded state which is pulled up to an unfolded state by a human hand. Thus, the plug assembly 3 can be freely folded and unfolded according to needs. When folded, the plug mechanism has a small volume, occupies a small space, is well accommodated, is convenient to be carried, and is particularly convenient to be carried abroad. When folded, the pins of the plug assembly 3 are less likely to come into contact with other items without phenomenons of dust, scratching, damage or bending.

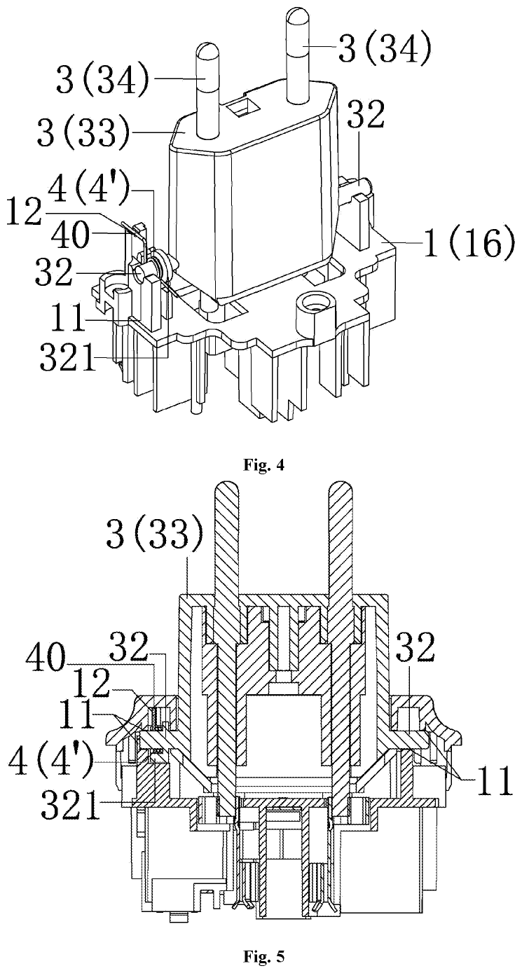

With regard to the mounting manner between the plug assembly 3 and the mounting base 1, as shown in FIGS. 3 to 6, the present embodiment has at least one rotation shaft 32 formed on the plug assembly 3. At least one rotation groove 11 into which the rotation shaft 32 is inserted for rotation is formed in the mounting base 1. Specifically, a rotation shaft 32 is respectively provided on opposite sides of the plug assembly 3, and a rotation groove 11 is respectively provided on both sides in the mounting base 1 for the rotation shaft 32 to be inserted and rotated, as shown in FIGS. 4 and 5. The rotation shaft 32 cooperates with the rotating groove 11, so that the plug assembly 3 can be rotated on the mounting base 1.

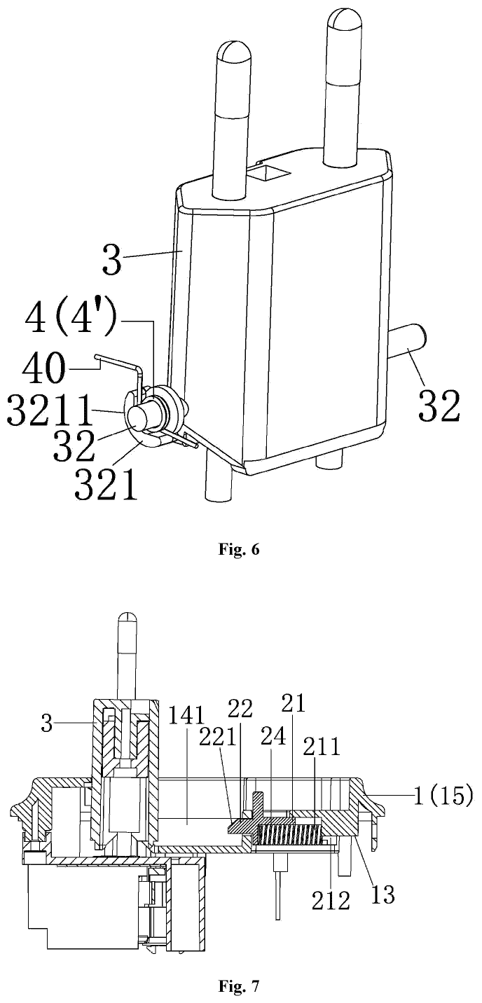

With regard to the specific structure and mounting method of the elastic member 4, as shown in FIGS. 4 and 6, the elastic member 4 is a torsion spring 4′ which is sleeved on the periphery of the rotation shaft 32 and one end of which abuts on the mounting base 1. Specifically, a clamp groove 12 into which one end 40 of the torsion spring 4′ is clamped is formed in the mounting base 1. When the rotation shaft 32 is rotated, since one end 40 of the torsion spring 4′ is clamped in the clamp groove 12 of the mounting base 1, the torsion spring 4′ does not rotate with the rotation shaft 32, but is twisted, that is, elastically deformed. Specifically, when the plug assembly 3 rotates from an unfolded state to a folded state, the torsion spring 4′ undergoes an elastic deformation. After being folded into place, the plug assembly 3 is locked by the locking assembly 2. When the locking assembly 2 unlocks the plug assembly 3, under the action of the elastic restoring force of the torsion spring 4′, the plug assembly 3 swings in the opposite direction to realize the popping operation of the plug assembly 3, which is convenient and quick.

In order to improve the rotational stability of the rotation shaft 32 and prevent the rotation shaft 32 from shaking, as shown in FIGS. 4 to 6, a rotation guide seat 321 is provided at the periphery of the rotation shaft 32, and an arc-shaped guide surface 3211 is formed at an outer side of the rotation guide seat 321. Specifically, the rotation guide seat 321 has a semicircular structure. When the rotation shaft 32 has the rotating action to switch between the unfolded state and the folded state, the rotation shaft 32 rotates by exactly 90°. In the whole rotating process, the rotation guide seat 321 with the arc-shaped guide surface 3211 plays a guiding role to improve the rotating stability of the rotation shaft 32.

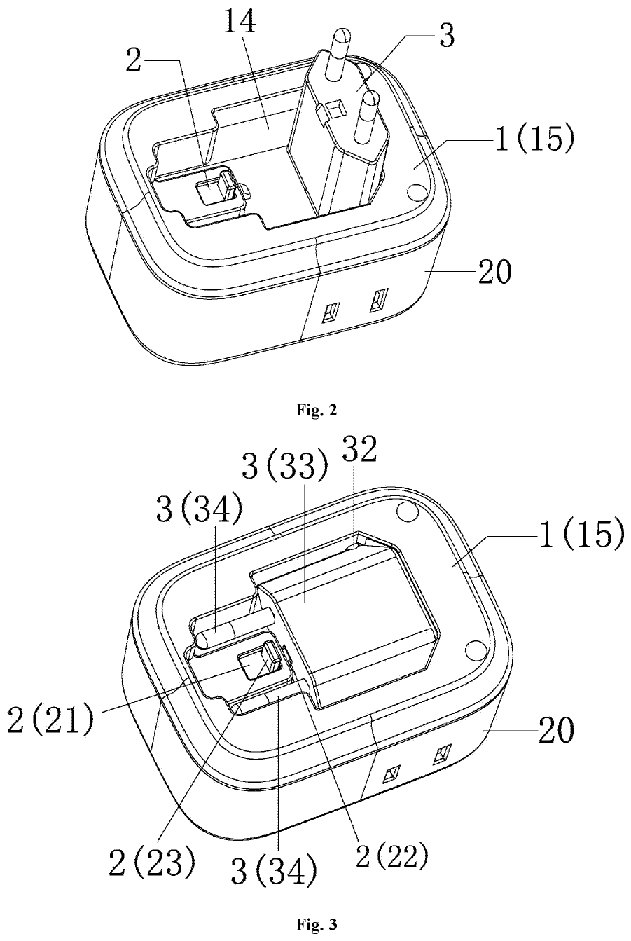

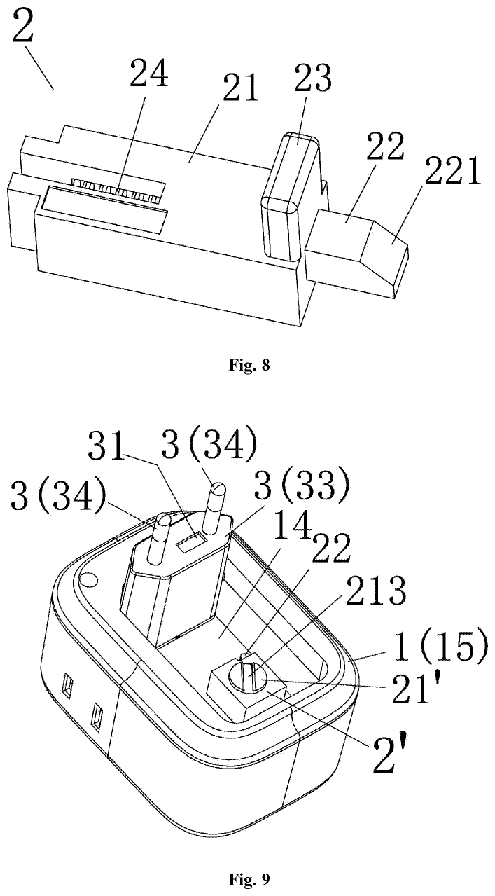

In the present embodiment, as shown in FIGS. 1, 3, 7 and 8, the locking assembly 2 includes a movable member 21 movably disposed on the mounting base 1, a locking block 22 connected to the movable member 21, an operation pushing block 23 disposed on an upper end of the movable member 21, and a first return spring 24 disposed between the movable member 21 and the mounting base 1. Among them, a first guide slope 221 is formed on an upper end surface of the locking block 22, and a second guide slope 30 corresponding to the first guide slope 221 is formed on the plug assembly 3. A locking groove 31 into which the locking block 22 is inserted is formed on the plug assembly 3. When the plug assembly 3 is in an unfolded state, as shown in FIGS. 1 and 2, both the first return spring 24 and the locking block 22 are in a natural state. When the plug assembly 3 is swung downwards so that the plug assembly 3 rotates until the second guide slope 30 acts on the first guide slope 221 of the locking block 22, the locking block 22 moves backwards to compress the first return spring 24 until the locking block 22 meets the locking groove 31, and the locking block 22 is clamped into the locking groove 31 under the elastic restoring force of the first return spring 24, so as to lock the plug assembly 3. The plug assembly 3 is in a folded state at this time. When it is required to unfold the plug assembly 3, the operation pushing block 23 is pushed backwards. The first return spring 24 is compressed as the locking block 22 moves backwards. After the locking block 22 leaves the locking groove 31, the plug assembly 3 is ejected to the unfolded state under the action of the torsion spring 4′. Then the locking block 22 is reset under the elastic restoring force of the first return spring 24. When the plug assembly 3 acts on the locking block 22, the plug assembly 3 is contacted by the second guide slope 30 and acts on the first guide slope 221, acting as a guide, making the folding operation easier and smoother.

By means of the locking assembly 2 formed by combining the movable member 21, the locking block 22, the operation pushing block 23 and the first return spring 24, the structure design is novel and reasonable. The plug assembly 3 in the folded state can be stably locked. The operation is convenient, quick, smooth and practical when the plug assembly 3 switches between the folded state and the unfolded state.

Meanwhile, as shown in FIG. 7, a guide sliding block 13 is disposed inside the mounting base 1. A movable cavity 211 is formed at the bottom of the movable member 21. A guide sliding hole 212 is formed on the movable member 21 to communicate with the movable cavity 211 and allow the guide sliding block 13 to slide. The first return spring 24 is disposed between the inner wall of the movable cavity 211 and the guide sliding block 13. The guide sliding block 13, in combination with the guide sliding hole 212, provides a guiding function for the movement of the movable member 21, improving the stability of the movement thereof.

In this embodiment, as shown in FIG. 1, the plug assembly 3 includes a plug body 33 and two pins 34 connected to the plug body 33. A folding groove 14 is formed on the mounting base 1, and the folding groove 14 includes a large groove body 141 for the plug body 33 to rotate. Two side grooves 142 communicating with the large groove body 141 for the two pins 34 to be clamped. The locking assembly 2 is disposed between the two side grooves 142. Thus, when the plug assembly 3 is folded, the plug body 33 of the plug assembly 3 can be clamped into the large groove body 141. The two pins 34 can be clamped into the two side grooves 142 respectively. The stability of the plug assembly 3 after folding is improved in combination with the locking function of the locking assembly 2.

In this embodiment, the mounting base 1 includes a lower cover 15 and a bracket 16 disposed at one side of the lower cover 15. The locking assembly 2 and the plug assembly 3 are respectively disposed on the lower cover 15. Meanwhile, as shown in FIGS. 4 and 5, a rotation groove 11 is formed between the lower cover 15 and the bracket 16, and a clamp groove 12 for clamping into one end 40 of the torsion spring 4′ is formed on the bracket 16.

The foldable plug mechanism 10 of the present embodiment is applied to a multi-national power converter. As shown in FIGS. 1 to 3, the lower cover 15 of the foldable plug mechanism 10 may be directly mounted to the housing 20 of the multi-national power converter.

### Embodiment II

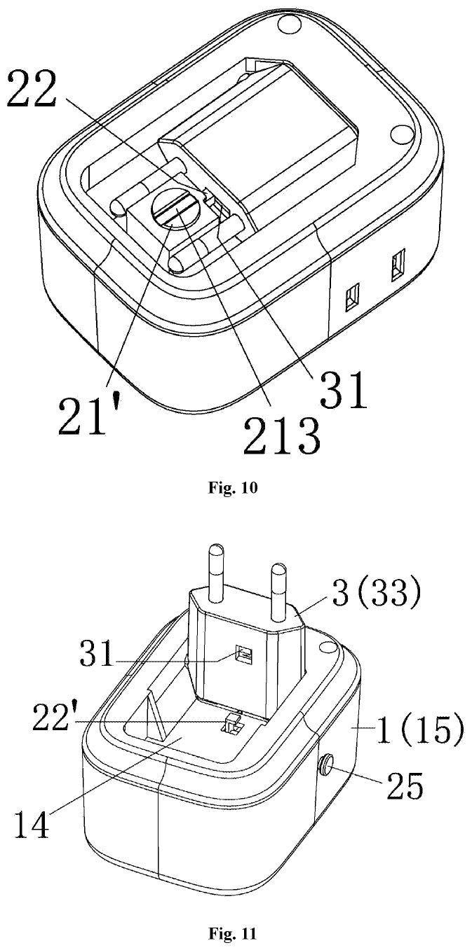

The main differences between this embodiment and Embodiment I are as follows. The structure of the locking assembly 2′ is different. Specifically, as shown in FIGS. 9 and 10, the movable member 21 in the locking assembly 2′ is a rotating member 21′ on which a rotating clamp groove 213 is formed. In the present embodiment, the rotating member 21′ can be moved only by a screwdriver or other tool. The rotating member 21′ does not rotate by itself when no force is applied to the rotating member 21′.

When the plug assembly 3 is in the unfolded state, as shown in FIG. 9, the locking block 22 is not in the locking groove 31. When it is required to fold the plug assembly 3, the plug assembly 3 is swung down into the folding groove 14. Then a screwdriver or other tool is used to clamp into the rotating clamp groove 213, with a rotating force applied to the rotating member 21′, i.e., the locking block 22 is driven to rotate in the direction of the locking groove 31, until the locking block 22 is clamped into the locking groove 31 to lock the plug assembly 3, and the plug assembly 3 is in a folded state, as shown in FIG. 10. When it is required to unfold the plug assembly 3, a screwdriver or other tool is used to clamp into the rotation clamp groove 213, with a reverse rotation force applied to the rotation member 21′, i.e., the locking block 22 is driven to rotate in a reverse direction until the locking block 22 leaves the locking groove 31. Then, under the action of the torsion spring 4′, the plug assembly 3 is ejected to an unfolded state, as shown in FIG. 9.

By means of the locking assembly 2′ formed by combining the rotating member 21′ and the locking block 22, the structure design is novel and reasonable. The plug assembly 3 in the folded state can be stably locked. The operation is convenient, quick, smooth and practical when the plug assembly 3 switches between the folded state and the unfolded state.

### Embodiment III

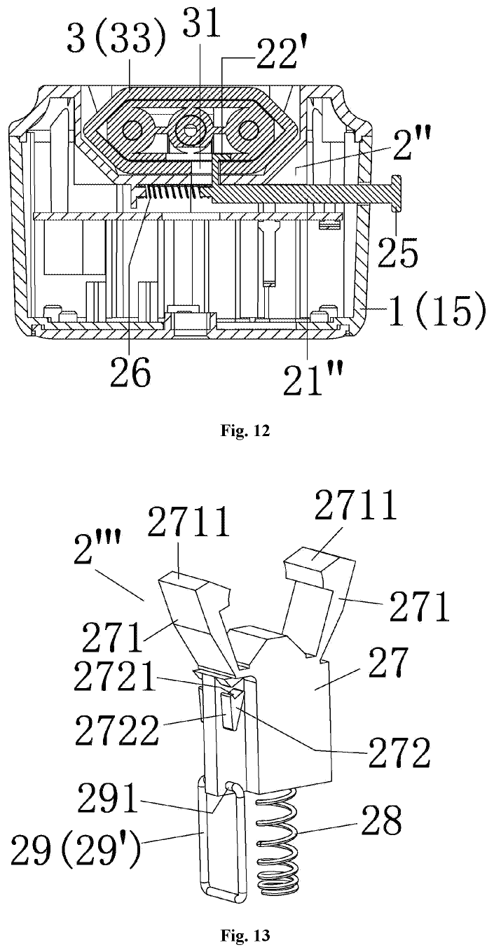

The main differences between this embodiment and Embodiment I are as follows. The structure of the locking assembly 2″ is different. Specifically, as shown in FIGS. 11 and 12, the movable member 21 is a press rod 21″, and the locking block 22 is a first locking hook 22′. The locking assembly 2″ also includes a first press handle 25 connected to an outer end of the press handle 21″ and extending outside of the mounting base 1, and a second return spring 26 disposed between an inner end of the press handle 21″ and the mounting base 1.

When the plug assembly 3 is in the unfolded state, as shown in FIG. 11, the second return spring 26 is in a natural state, and the first locking hook 22′ does not catch the plug assembly 3. When it is required to fold the plug assembly 3, the first press handle 25 is pressed towards the inside of the mounting base 1, then the press rod 21″ and the first locking hook 22′ move together, and the second return spring 26 is compressed. Then, the plug assembly 3 is swung down into the folding groove 14, and the first locking hook 22′ enters the locking groove 31. Then, when the pressing of the first press handle 25 is released, under the action of the elastic restoring force of the second return spring 26, the press rod 21″ and the first locking hook 22′ are driven to move in a reverse direction and return, so that the first locking hook 22′ moves to hook the plug assembly 3, thereby locking the plug assembly 3. At his time, the plug assembly 3 is in a folded state, as shown in FIG. 12.

When it is required to unfold the plug assembly 3, the first press handle 25 is pressed towards the inner side of the mounting base 1, so that the press rod 21″ moves along with the first locking hook 22′, and the second return spring 26 is compressed. At this time, the first locking hook 22′ no longer hooks the plug assembly 3. Then, under the action of the torsion spring 4′, the plug assembly 3 pops up to the unfolded state, as shown in FIG. 11. At the same time, when the pressing of the first press handle 25 is released, under the elastic restoring force of the second return spring 26, the press rod 21″ and the first locking hook 22′ are driven to move in the opposite direction and return.

With the locking assembly 2″ formed by combining the press rod 21″, the first locking hook 22′, the first press handle 25 and the second return spring 26, the structure design is novel and reasonable. The plug assembly 3 in the folded state can be stably locked. The operation is convenient, quick, smooth and practical when the plug assembly 3 switches between the folded state and the unfolded state.

### Embodiment IV

The main differences between this embodiment and Embodiment I are as follows. The structure of the locking assembly 2′″ is different. Specifically, as shown in FIGS. 13-18, the locking assembly 2′″ includes a press seat 27 movably disposed on the mounting base 1, two locking arms 271 rotatably disposed on the press seat 27, a third return spring 28 disposed between the press seat 27 and the mounting base 1, and a fastener 29 disposed on the mounting base 1 and used for fastening the press seat 27. A movable groove 17 for moving the press seat 27, the third return spring 28 and the fastener 29 is formed on the mounting base 1. Two limiting blocks 171 for limiting the two locking arms 271 are formed on an upper end of the movable groove 17. By means of the locking assembly 2′″ formed by combining the press seat 27, the two locking arms 271, the third return spring 28 and the fastener 29, the structure design is novel and reasonable. The plug assembly 3 in the folded state can be stably locked. The operation is convenient, quick, smooth and practical when the plug assembly 3 switches between the folded state and the unfolded state.

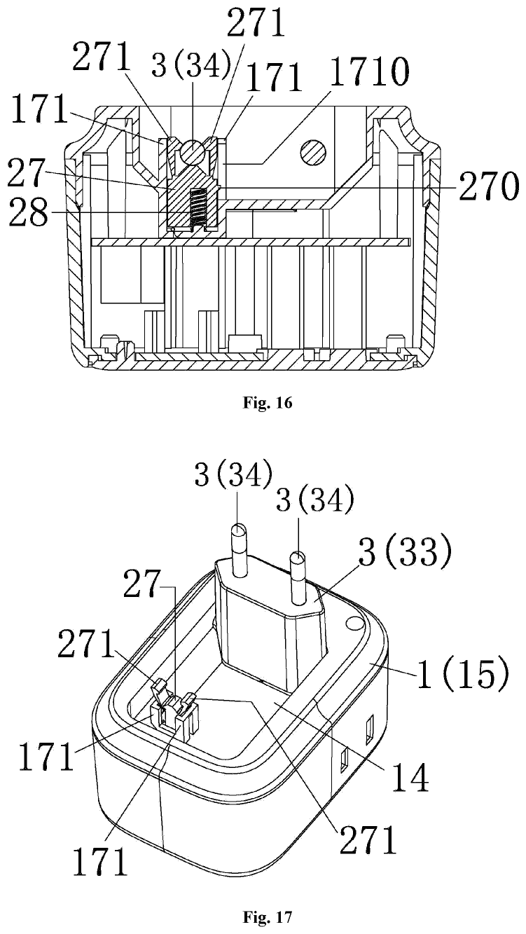

Meanwhile, a guide block 270 is formed on a side of the press seat 27, and a longitudinal sliding groove 1710 for sliding the guide block 270 is formed on one of the guide block 171, as shown in FIG. 16. When the press seat 27 moves up and down, the guide block 270 slides in the longitudinal sliding groove 1710, thereby providing a guide action to improve the stability of the press seat 27 when moving up and down.

In order to more stably lock the pins 34 of the plug assembly 3, the present embodiment is formed with a first locking hook 2711 at the ends of the two locking arms 271, respectively. In the folded state of the plug assembly 3, the pins 34 are directly restrained from both sides by the two first locking hooks 2711 of the two locking arms 271, as shown in FIGS. 16 and 18, to achieve the locking effect.

In this embodiment, the fastener 29 is a springing bar 29′ with at least one clamp hook 291 formed thereon. At the same time, at least one protrusion 272 is formed on the press seat 27. A fastening position 2721 for fastening the clamp hook 291 is formed on the upper end of the protrusion 272. The fastening position 2721 of the protrusion 272 can be hooked by the clamp hook 291 of the springing bar 29′ so as to limit the press seat 27. Preferably, the number of the clamp hooks 291 and the projections 272 in the present embodiment is two, respectively, and disposed in one-to-one correspondence. Meanwhile, a slope 2722 is formed at a side of the protrusion 272, and the slope 2722 is inclined from bottom to top in a direction away from the fastening position 2721. The slope 2722 is provided to guide the springing of the springing bar 29′, so that after being moved into position, the clamp hook 291 of the springing bar 29′ can be directly sprung and hooked into the fastening position 2721.

With regard to the installation of the third return spring 28, as shown in FIG. 15, a positioning groove 273 is formed at the bottom of the press seat 27. A positioning post 172 is formed at the bottom in the movable groove 17. The upper end of the third return spring 28 is inserted into the positioning groove 273. The lower end is sleeved on the periphery of the positioning post 172. The positioning groove 273 and the positioning post 172 are combined to limit the deformation of the third return spring 28, so as to prevent the third return spring 28 from swinging left or right, thereby facilitating stable elastic deformation of the third return spring 28.

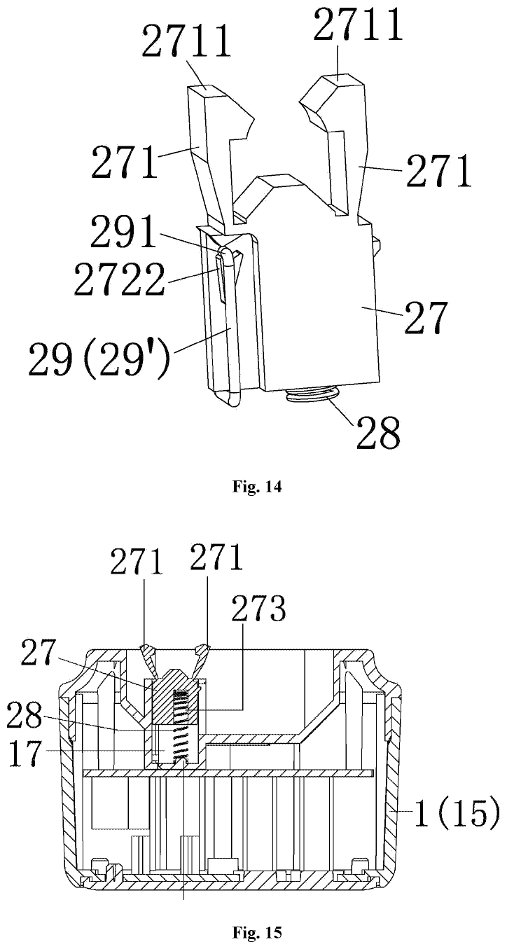

When the plug assembly 3 is in the unfolded state, as shown in FIGS. 13, 15 and 17, the third return spring 28 is in the natural state, the two locking arms 271 on the press seat 27 are in the unfolded state, and the two locking arms 271 do not catch the pins 34 of the plug assembly 3. When it is required to fold the plug assembly 3, the plug assembly 3 is swung down into the folding groove 14, the pin 34 applies a downward acting force to the press seat 27, and then the press seat 27 drives the two locking arms 271 to move downwards. In the process of the two locking arms 271 moving downwards, the two locking arms 271 are continuously closed under the action of the two limiting blocks 171 until the first locking hook 2711 hooks the pin 34. At the same time, during the downward movement of the press seat 27, the springing bar 29′ slides on the press seat 27. When encountering the slope 2722 of the protrusion 272, the springing bar moves outwards under the guide action of the slope 2722 to generate elastic deformation until moving to the upper end of the slope 2722, thereby springing and snapping into the fastening position 2721. Thus, the press seat 27 is limited by the springing bar 29′, and the pin 34 is locked by the first locking hooks 2711 of the two locking arms 271. At this time, the third return spring 28 is compressed. Thereby, the locking of the plug assembly 3 is achieved when the plug assembly 3 is in a folded state, as shown in FIGS. 14, 16 and 18.

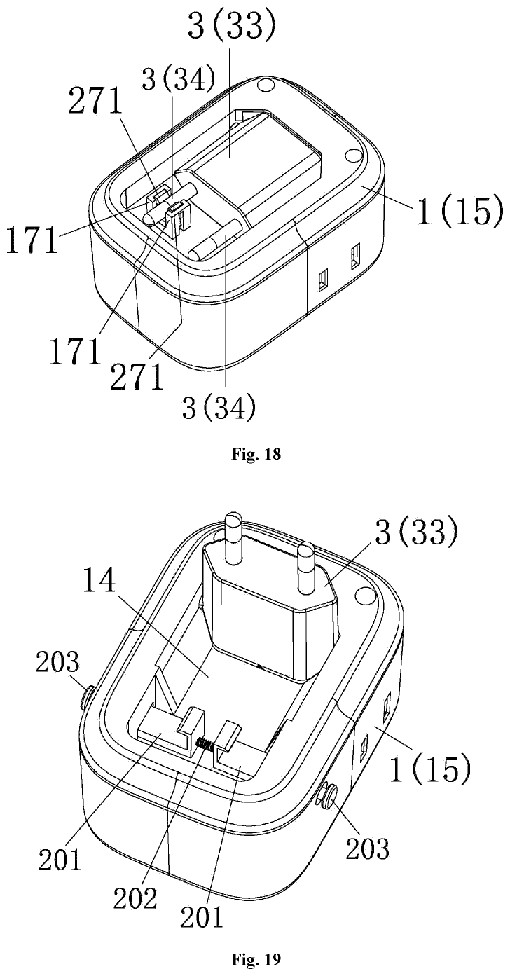

When the plug assembly 3 needs to be unfolded, the pin 34 of the plug assembly 3 is pressed downwards again. The pin 34 applies a downward acting force to the press seat 27, and then the press seat 27 moves downwards, so that the springing bar 29′ disengages from the fastening position 2721, and thus disengages from the protrusion 272. The springing bar 29′ releases the limiting position on the press seat 27. Under the action of the elastic restoring force of the third reset spring 28, the press seat 27 drives the two locking arms 271 to move upwards and reset. In the process of moving upwards, the two locking arms 271 continuously disengage from the two limiting blocks 171 until the two locking arms 271 completely spread apart, releasing the locking on the pin 34. Then, under the action of the torsion spring 4′, the plug assembly 3 is ejected to the unfolded state, as shown in FIG. 17.

### Embodiment 5

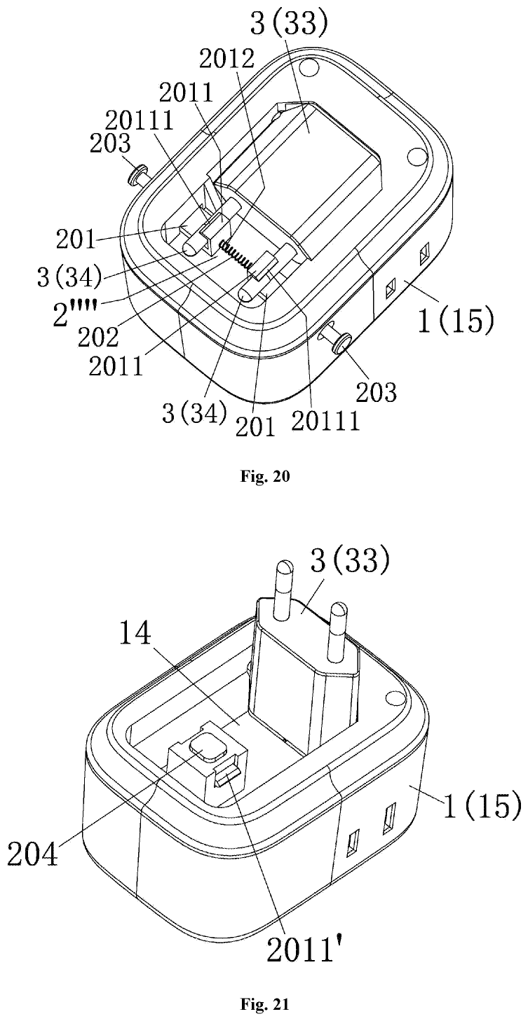

The main differences between this embodiment and Embodiment I are as follows. The locking assembly 2″″ differs in structure. In particular, as shown in FIGS. 19 and 20, the locking assembly 2″″ includes two movable seats 201 movably disposed on the mounting base 1 and at least a fourth return spring 202 abutting against the movable seats 201. A second locking hook 2011 is formed on the two movable seats 201, respectively. By means of the locking assembly 2″″ formed by combining two movable seats 201 having a second locking hook 2011 and a fourth return spring 202, the structure design is novel and reasonable. The plug assembly 3 in the folded state can be stably locked. The operation is convenient, quick, smooth and practical when the plug assembly 3 switches between the folded state and the unfolded state.

In order to facilitate the pins 34 of the plug assembly 3 to be better clamped into the second locking hook 2011, the present embodiment is formed with a third guide slope 20111 on the upper end surface of the second locking hook 2011.

In the present embodiment, a second press handle 203 extending outside the mounting base 1 is connected to the movable seat 201. By operating the second press handle 203, the two movable seats 201 can be moved inwards on the mounting base 1.

With regard to the installation of the fourth return spring 202, the two movable seats 201 are oppositely disposed, and a sleeve post 2012 is respectively formed on the back surfaces of the two movable seats 201. Both ends of the fourth return spring 202 are sleeved on the periphery of the sleeve post 2012.

When the plug assembly 3 is in the unfolded state, as shown in FIG. 19, the fourth return spring 202 is in a natural state, and the second locking hook 2011 does not catch the plug assembly 3. When it is required to fold the plug assembly 3, the plug assembly 3 is swung down into the folding groove 14, and the pins 34 of the plug assembly 3 contact and act downward on the third guide slope 20111, so that the two movable seats 201 move relative to each other until the pins 34 are clamped into the second locking hooks 2011. The two pins 34 are simultaneously locked by the second locking hooks 2011 on the two movable seats 201 under the elastic engagement of the fourth return spring 202, thereby locking the plug assembly 3. At this time, the plug assembly 3 is in a folded state, as shown in FIG. 20.

When it is required to unfold the plug assembly 3, the second press handles 203 on the two movable seats 201 are pressed at the same time towards the inner side of the mounting base 1, then the two movable seats 201 move closer relative to each other, and the fourth return spring 202 is compressed. At this time, the second locking hook 2011 is disengaged from the pin 34 and no longer hooks the pin 34. Then, under the action of the torsion spring 4′, the plug assembly 3 pops up to the unfolded state, as shown in FIG. 19. At the same time, when the pressing of the second press handle 203 is released, under the elastic restoring force of the fourth return spring 202, the two movable seats 201 with the second locking hooks 2011 are driven to move in a reverse direction and return.

### Embodiment 6

The main differences between this embodiment and Embodiment I are as follows. The locking assembly 2″″ has a different structure. Specifically, as shown in FIGS. 21 to 25, the locking assembly 2′″″ includes two movable seats 201′ movably disposed on the mounting base 1, at least one fourth return spring 202′ abutting against the movable seats 201′, a press member 204 disposed above the two movable seats 201′, and a fifth return spring 205 disposed between the press member 204 and the mounting base 1. A second locking hook 2011′ is respectively formed on the two movable seats 201′. By means of the locking assembly 2′″″ formed by combining two movable seats 201′ having a second locking hook 2011′, a fourth return spring 202′, a fifth return spring 205 and a press member 204, the structure design is novel and reasonable. The plug assembly 3 in the folded state can be stably locked. The operation is convenient, quick, smooth and practical when the plug assembly 3 switches between the folded state and the unfolded state.

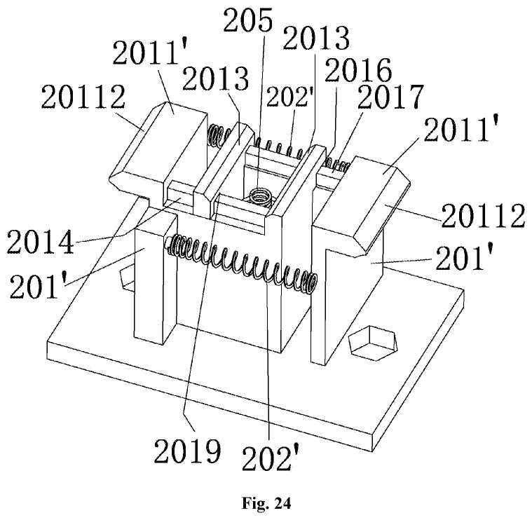

In order to facilitate pressing, as shown in FIGS. 23 and 24, an upper press guide slope 2013 is formed on the two movable seats 201′, respectively; and two lower press guide slopes 2041 acting on the upper press guide slopes 2013 of the two movable seats 201′ are formed on the press member 204, respectively. When the press member 204 is pressed downwards, the lower press guide slope 2041 of the lower end surface of the press member 204 simultaneously acts downward on the upper press guide slopes 2013 of the two movable seats 201′, i.e., the two movable seats 201′ are brought to slide closer to each other, thereby enabling the two second locking hooks 2011′ of the two movable seats 201′ to leave the pins 34 of the plug assembly 3. The matching design of the upper press guide slope 2013 and the lower press guide slope 2041 plays a guiding role, facilitating the function of accurate and stable pressing.

In order to facilitate the pins 34 of the plug assembly 3 be better clamped into the second latching hook 2011′, the present embodiment is formed with a fourth guide slope 20112 on the upper end surface of the second latching hook 2011′.

In the present embodiment, as shown in FIGS. 23 and 24, the number of the fourth return springs 202′ is two. One fourth return spring 202′ is located between one of the movable seats 201′ and the mounting base 1, and the other fourth return spring 202′ is located between the other movable seat 201′ and the mounting base 1. The combination of the two fourth return springs 202′ provides a stable elastic restoring force for the left-right sliding of the two movable seats 201′.

In order to improve the left-right sliding stability of the two movable seats 201′, as shown in FIGS. 23 and 24, a first guide sliding rail 2014 and a first guide sliding bar 2015 are respectively formed on one of the two movable seats 201′, and a first sliding groove 2016 is formed on the first guide sliding bar 2015. A second guide sliding rail 2017 and a second guide sliding bar 2018 are respectively formed on the other movable seat 201′, and a second sliding groove 2019 is formed on the second guide sliding bar 2018. The first guide sliding rail 2014 is movably clamped into the second sliding groove 2019, and the second guide sliding rail 2017 is movably clamped into the first sliding groove 2016, thereby providing a linear guide action for the translation of the two movable seats 201′, which are movable towards and away from each other, facilitating the unfolding and folding action of the plug assembly 3.

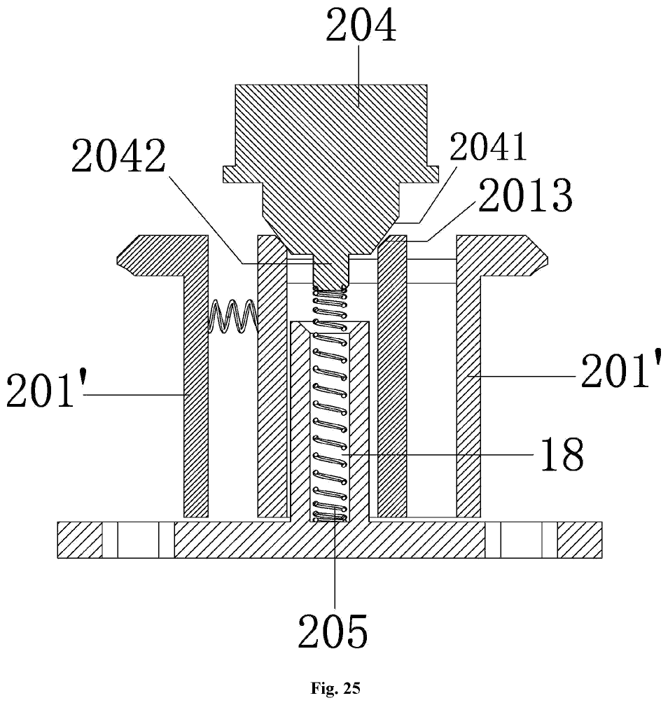

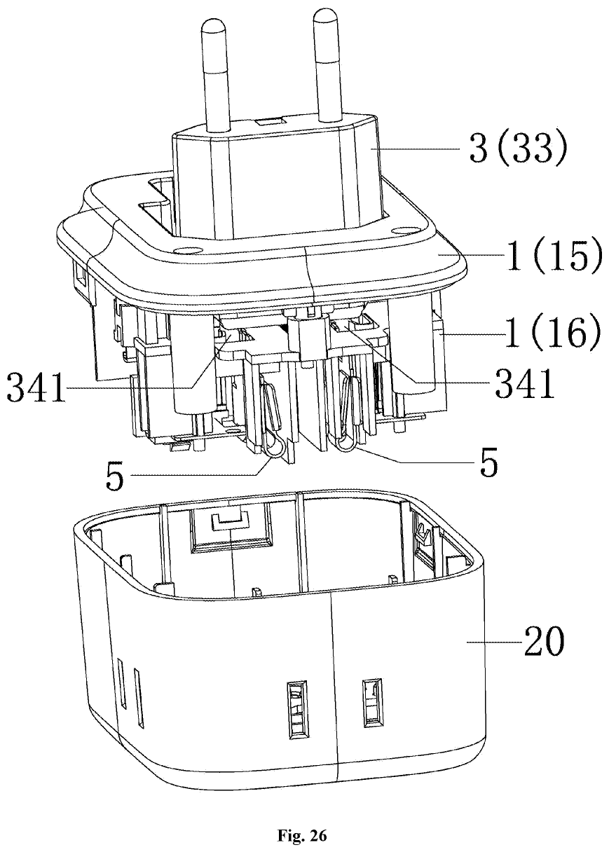

With regard to the mounting of the fifth return spring 205, as shown in FIG. 25, an upper mounting post 2042 is formed at a lower end of the press member 204. A lower mounting groove 18 is formed at the mounting base 1. An upper end of the fifth return spring 205 is sleeved on the periphery of the upper mounting post 2042, and a lower end thereof is sleeved on the periphery of the lower mounting groove 18. As a result, the fifth return spring 205 is limited so as to prevent the fifth return spring 205 from swinging left or right and improve the stability of the fifth return spring 205 in elastic deformation.

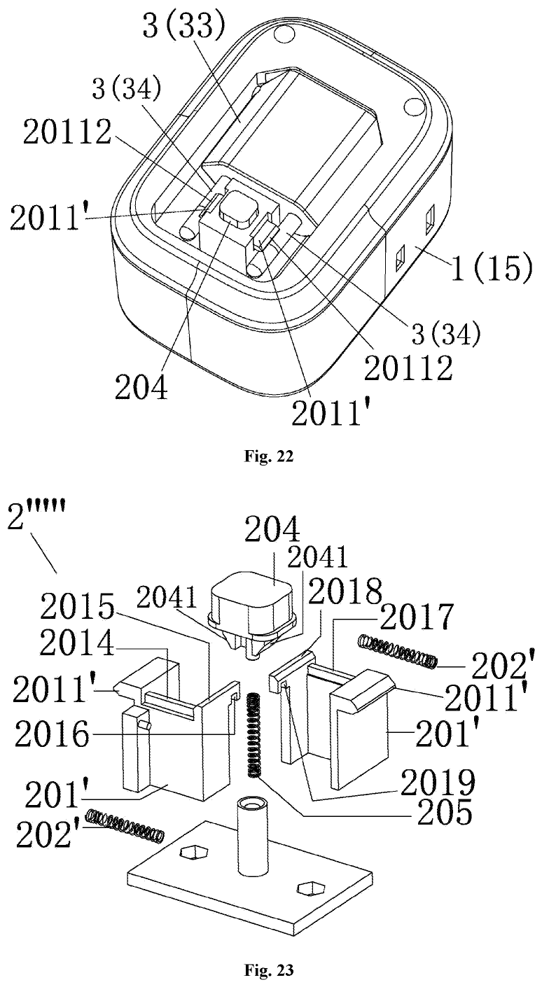

When the plug assembly 3 is in the unfolded state, as shown in FIG. 21, the two fourth return springs 202′ are in the natural state, and the second locking hooks 2011′ do not catch the plug assembly 3. When it is required to fold the plug assembly 3, the plug assembly 3 is swung down into the folding groove 14, and the pins 34 of the plug assembly 3 contact and act downward on the fourth guide slope 20112, so that the two movable seats 201′ move close to each other until the pins 34 are clamped into the second locking hooks 2011′. The two pins 34 are simultaneously locked by the second locking hooks 2011′ on the two movable seats 201′ under the elastic engagement of the fourth return spring 202′, thereby locking the plug assembly 3. The plug assembly 3 is in a folded state, as shown in FIG. 22.

When it is required to unfold the plug assembly 3, the press member 204 is pressed downwards, and the lower press guide slope 2041 of the lower end surface of the press member 204 simultaneously acts downwards on the upper press guide slope 2013 of the two movable seats 201′, so that the two movable seats 201′ are driven to slide close to each other. At this time, the fourth return spring 202′ and the fifth return spring 205 are both compressed until the second locking hook 2011′ is disengaged from the pin 34 and the pin 34 is no longer hooked. Then, under the action of the torsion spring 4′, the plug assembly 3 pops up to the unfolded state, as shown in FIG. 21. Then, when the pressing of the press member 204 is released, under the elastic restoring force of the fourth return spring 202′ and the fifth return spring 205, the two movable seats 201′ with the second locking hook 2011′ and the press member 204 are driven to move in a reverse direction and return.

### Embodiment 7

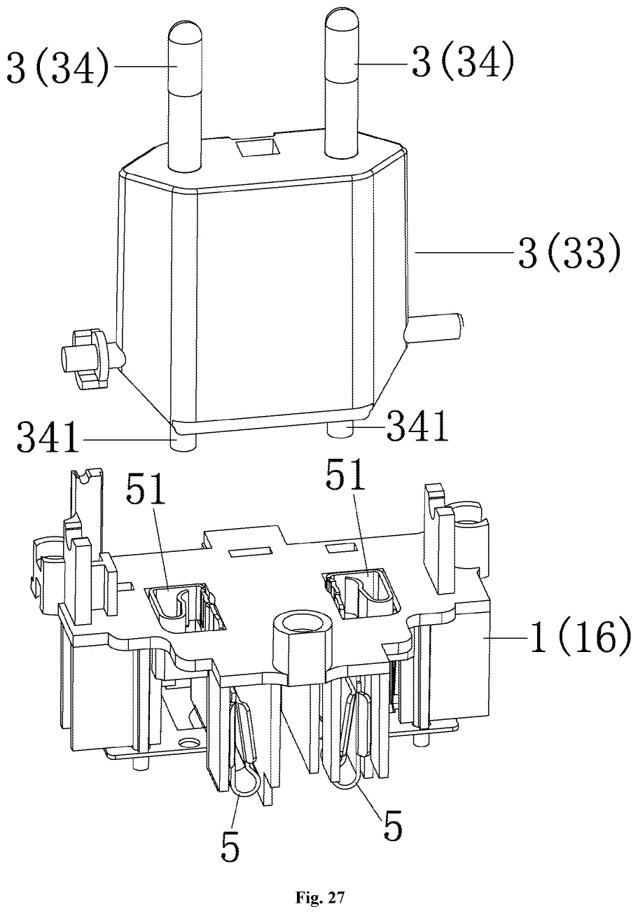

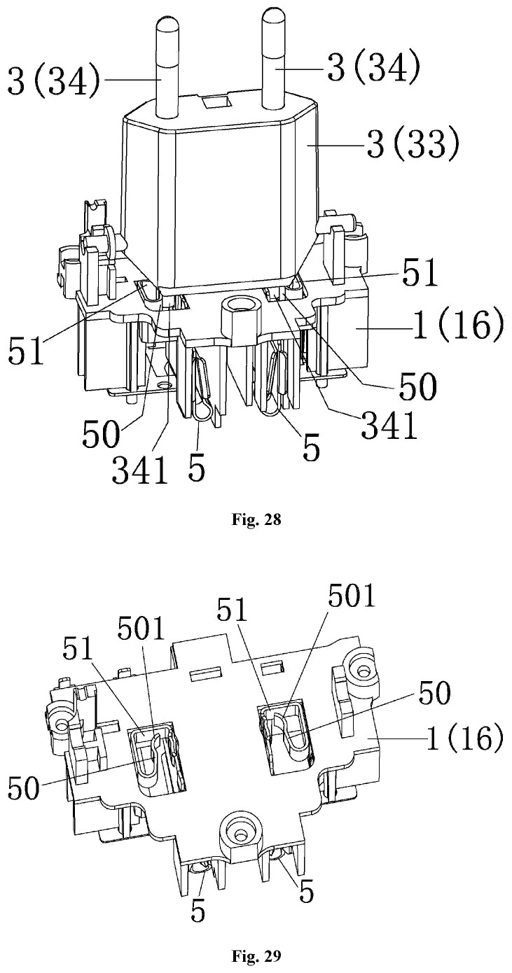

This embodiment differs from any one of embodiments I to VI mainly in that: as shown in FIGS. 26 and 27, at least two sets of conductive elastic members 5 are provided on one side of the mounting base 1. An arc-shaped contact spring piece 50 is formed on the conductive elastic members 5 for contacting and conducting a tail end 341 of the plug assembly 3, as shown in FIGS. 28 and 29. Specifically, the tail ends 341 of the two pins 34 of the plug assembly 3 is in contact with the conductive elastic member 5. The arc-shaped contact spring piece 50 directly contacts the tail end 341 of the pin 34, so that it realizes the conduction function, and at the same time, the arc-shaped contact spring piece 50 applies an elastic force to the tail end 341 of the pin 34 to position same so as to improve the stability of the contact between the pin 34 and the arc-shaped contact spring piece 50, and ensure the contact performance and good contact. It ensures the use of a large current, for example, a large current of 15 A.

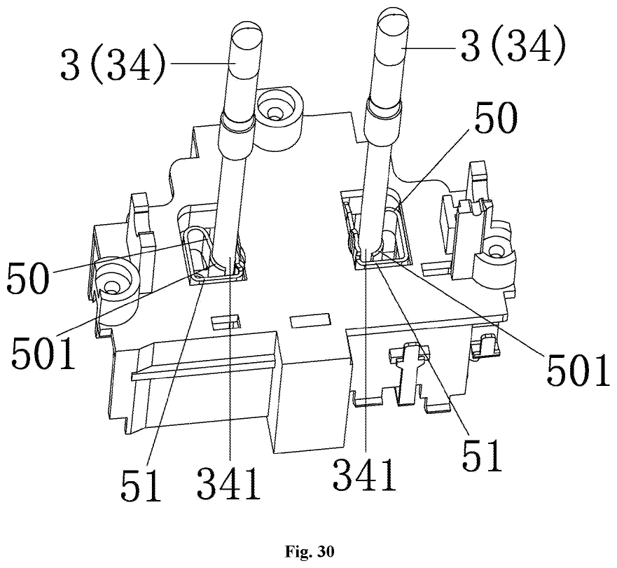

Specifically, a conductive contact clip 51 for inserting and contacting the tail end of the plug assembly 3 is formed on the conductive elastic member 5. One side of the conductive contact clip 51 is bent and extended inwards to form the arc-shaped contact spring piece 50. The free end of the arc-shaped contact spring piece 50 has an arc-shaped covering portion 501, as shown in FIG. 29. When the tail end 341 of the pin 34 of the plug assembly 3 is clamped into the conductive contact clip 51, the tail end 341 of the pin 34 contacts and pushes the arc-shaped contact spring piece 50 inwards. After pushing into place, the arc-shaped covering portion 501 directly and tightly covers the tail end 341 of the pin 34, as shown in FIG. 30, further improving the stability of the contact between the pin 34 and the whole conductive elastic member 5, ensuring the contact performance and good contact, thereby ensuring the use of a large current.

In this embodiment, the conductive elastic member 5, the arc-shaped contact spring piece 50, the conductive contact clip 51 and the arc-shaped covering portion 501 are all copper plates, and have electrical conductivity and elastic properties.

In this embodiment, the conductive elastic member 5 is provided in the bracket 16, as shown in FIGS. 26 and 27.

Specifically, when the plug assembly 3 is in a folded state, the tail ends 341 of the two pins 34 of the plug assembly 3 leave the conductive contact clip 51 of the conductive elastic member 5, and do not contact the conductive elastic member 5. When the plug assembly 3 is in the unfolded state, as shown in FIG. 30, the tail ends 341 of the two pins 34 of the plug assembly 3 are clamped into the conductive contact clip 51, and are tightly covered by the arc-shaped covering portion 501 of the arc-shaped contact spring piece 50, with stable and good contact, so as to ensure the use of a large current.

In the description above, only the preferred embodiments of the invention has been described, and the technical scope of the invention is not limited in any way. Therefore, other structures obtained by adopting the same or similar technical features as those of the above embodiments of the invention are within the scope of the invention.

1. A foldable plug mechanism applied to a multi-national power converter, comprising:
a mounting base;
a plug assembly rotatably disposed on the mounting base;
a locking assembly disposed on the mounting base for locking the plug assembly; and
at least one elastic member disposed between the plug assembly and the mounting base.

2. The foldable plug mechanism applied to the multi-national power converter according to claim 1, wherein at least one rotation shaft is formed on the plug assembly, and at least one rotation groove into which the rotation shaft is inserted for rotation is formed in the mounting base.

3. The foldable plug mechanism applied to the multi-national power converter according to claim 2, wherein the elastic member is a torsion spring which is sleeved on the periphery of the rotation shaft and one end of which abuts on the mounting base.

4. The foldable plug mechanism applied to the multi-national power converter according to claim 3, wherein a clamp groove into which one end of the torsion spring is clamped is formed in the mounting base.

5. The foldable plug mechanism applied to the multi-national power converter according to claim 2, wherein a rotation guide seat is provided at the periphery of the rotation shaft, and an arc guide surface is formed at an outer side of the rotation guide seat.

6. The foldable plug mechanism applied to the multi-national power converter according to claim 1, wherein the locking assembly comprises a movable member movably disposed on the mounting base and a locking block connected to the movable member; and a locking groove into which the locking block is inserted is formed on the plug assembly.

7. The foldable plug mechanism applied to the multi-national power converter according to claim 6, wherein the locking assembly further comprises an operation pushing block disposed at an upper end of the movable member, and a first return spring disposed between the movable member and the mounting base, wherein a first guide slope is formed at an upper end surface of the locking block, and a second guide slope corresponding to the first guide slope is formed at the plug assembly.

8. The foldable plug mechanism applied to the multi-national power converter according to claim 7, wherein a guide sliding block is disposed inside the mounting base; a movable cavity is formed at the bottom of the movable member; a guide sliding hole is formed on the movable member to communicate with the movable cavity and allow the guide sliding block to slide; and the first return spring is disposed between the inner wall of the movable cavity and the guide sliding block.

9. The foldable plug mechanism applied to the multi-national power converter according to claim 6, wherein the movable member is a rotating member on which a rotating clamp groove is formed.

10. The foldable plug mechanism applied to the multi-national power converter according to claim 6, wherein the movable member is a press rod and the locking block is a first locking hook; the locking assembly also comprises a first press handle connected to an outer end of the press rod and extending outside of the mounting base, and a second return spring disposed between an inner end of the press rod and the mounting base.

11. The foldable plug mechanism applied to the multi-national power converter according to claim 1, wherein the locking assembly comprises a press seat movably disposed on the mounting base, two locking arms rotatably disposed on the press seat, a third return spring disposed between the press seat and the mounting base, and a fastener disposed on the mounting base and used for fastening the press seat; a movable groove for moving the press seat, the third return spring and the fastener is formed on the mounting base; and two limiting blocks for limiting the two locking arms are formed on an upper end of the movable groove.

12. The foldable plug mechanism applied to the multi-national power converter according to claim 11, wherein a first locking hook is formed at ends of the two locking arms respectively.

13. The foldable plug mechanism applied to the multi-national power converter according to claim 11, wherein the fastener is a springing bar with at least one clamp hook formed thereon.

14. The foldable plug mechanism applied to the multi-national power converter according to claim 13, wherein at least one protrusion is formed on the press seat; a fastening position for fastening the clamp hook is formed on an upper end of the protrusion; and a slope is formed on a side of the protrusion, the slope being inclined from bottom to top in a direction away from the fastening position.

15. The foldable plug mechanism applied to the multi-national power converter according to claim 14, wherein the number of the clamp hooks and the protrusions is two, respectively, and disposed in one-to-one correspondence.

16. The foldable plug mechanism applied to the multi-national power converter according to claim 11, wherein a positioning groove is formed at the bottom of the press seat; a positioning post is formed at the bottom of the movable groove; the upper end of the third return spring is inserted into the positioning groove; and the lower end is sleeved on the periphery of the positioning post.

17. The foldable plug mechanism applied to the multi-national power converter according to claim 1, wherein the locking assembly comprises two movable seats movably disposed on the mounting base and at least a fourth return spring abutting against the movable seats, wherein a second locking hook is formed on the two movable seats, respectively; wherein a third guide slope is formed on an upper end surface of the second locking hook; wherein a second press handle extending outside the mounting base is connected to the movable seat; wherein the two movable seats are oppositely disposed, and a sleeve post is respectively formed on back surfaces of the two movable seats; and both ends of the fourth return spring are sleeved on the periphery of the sleeve post.

18. The foldable plug mechanism applied to the multi-national power converter according to claim 17, wherein the locking assembly further comprises a press member disposed above the two movable seats and a fifth return spring disposed between the press member and the mounting base; wherein an upper press guide slope is formed on the two movable seats, respectively; and two lower press guide slopes acting on the upper press guide slopes of the two movable seats are formed on the press member, respectively; wherein a fourth guide slope is formed on an upper end surface of the second locking hook; wherein the number of the fourth return springs is two, one fourth return spring being located between one of the movable seats and the mounting base, and the other fourth return spring being located between the other movable seat and the mounting base; wherein a first guide sliding rail and a first guide sliding bar are respectively formed on one of the two movable seats, and a first sliding groove is formed on the first guide sliding bar; a second guide sliding rail and a second guide sliding bar are respectively formed on the other movable seat, and a second sliding groove is formed on the second guide sliding bar; and the first guide sliding rail is movably clamped into the second sliding groove, and the second guide sliding rail is movably clamped into the first sliding groove; wherein an upper mounting post is formed at a lower end of the press member; a lower mounting groove is formed at the mounting base; and an upper end of the fifth return spring is sleeved on the periphery of the upper mounting post, and a lower end thereof is sleeved on the periphery of the lower mounting groove.

19. The foldable plug mechanism applied to the multi-national power converter according to claim 1, wherein the plug assembly comprises a plug body and two pins connected to the plug body; a folding groove is formed on the mounting base, and the folding groove comprises a large groove body for the plug body to rotate; and two side grooves communicating with the large groove body for the two pins to be clamped; wherein at least two sets of conductive elastic members are provided on one side of the mounting base; and an arc-shaped contact spring piece is formed on the conductive elastic member for contacting and conducting a tail end of the plug assembly; wherein a conductive contact clip for inserting and contacting the tail end of the plug assembly is formed on the conductive elastic member; one side of the conductive contact clip is bent and extended inwards to form the arc-shaped contact spring piece; and a free end of the arc-shaped contact spring piece has an arc-shaped covering portion; wherein the mounting base comprises a lower cover and a bracket disposed at one side of the lower cover; the conductive elastic member is disposed in the bracket; and the locking assembly and the plug assembly are respectively disposed on the lower cover.
